(19) United States
(12) Patent Application Publication
(10) Pub. No.: US 2026/0185899 A1
(43) Pub. Date: Jul. 2, 2026

(54) TESTING FIBER-OPTIC CABLE WITH A MOBILE DEVICE

(71) Applicant: T-Mobile USA, Inc., Bellevue, WA (US)

(72) Inventors: Matthew Brian Bell, Overland Park, KS (US); Mark Edgely, Frisco, TX (US); Sathiya Krishnaswamy Narayanan, Leesburg, VA (US)

(21) Appl. No.: 19/006,788

(22) Filed: Dec. 31, 2024

(51) Int. Cl. G01M 11/00

(52) U.S. Cl. CPC G01M 11/33

(57) ABSTRACT

An apparatus for measuring a light level in a fiber-optic cable using a mobile device is disclosed. The apparatus includes an adapter that has a sensor end and a connector. The connector is configured to couple to the fiber-optic cable to be tested. The sensor end includes a gasket for blocking light between the adapter and the mobile device. The apparatus further includes an arm coupled to the adapter. The adapter can be slid between a proximal end and a distal end of the arm. The apparatus also includes an attachment base connected to the arm. The attachment base can hold a back surface of the mobile device.

### BACKGROUND

A fiber-optic cable, also known as an optical-fiber cable, is an assembly similar to an electrical cable but containing one or more optical fibers that are used to carry light. The optical-fiber elements are typically individually coated with plastic layers and contained in a protective tube suitable for the environment where the cable is used. Different types of cable are used for fiber-optic communication in different applications, for example long-distance telecommunication or providing a high-speed data connection between different parts of a building.

Optical fibers are very strong, but the strength is drastically reduced by unavoidable microscopic surface flaws inherent in the manufacturing process. The initial fiber strength, as well as its change with time, must be considered relative to the stress imposed on the fiber during handling, cabling, and installation for a given set of environmental conditions. There are three basic scenarios that can lead to strength degradation and failure by inducing flaw growth: dynamic fatigue, static fatigue, and zero-stress aging.

An optical-fiber connector is a device used to link optical fibers, facilitating the efficient transmission of light signals. An optical-fiber connector enables quicker connection and disconnection than a splice, which is a temporary junction of two or more optical fibers that are aligned and held in place so that light can pass from one to another. Optical-fiber connectors come in various types such as a Subscriber Connector (SC), a Lucent Connector (LC), a straight tip (ST) connector, a ferrule connector (FC), and a mechanical transfer registered jack (MT-RJ) connector, each designed for specific applications.

### BRIEF DESCRIPTION OF THE DRAWINGS

Detailed descriptions of implementations of the present invention will be described and explained through the use of the accompanying drawings.

FIG. 1A illustrates an example of a testing configuration in accordance with one or more embodiments of the present technology.

FIG. 1B illustrates another example of a testing configuration in accordance with one or more embodiments of the present technology.

FIG. 2A illustrates an example of a testing apparatus in accordance with one or more embodiments of the present technology.

FIG. 2B illustrates another example of a testing apparatus in accordance with one or more embodiments of the present technology.

FIG. 3A illustrates a top view, a back view, and a side view of another example of a testing apparatus in accordance with one or more embodiments of the present technology.

FIG. 3B illustrates a back view of another example of a testing apparatus in accordance with one or more embodiments of the present technology.

FIG. 4 illustrates a top view, a back view, and a side view of another example of a testing apparatus in accordance with one or more embodiments of the present technology.

FIG. 5 is a flowchart of a process in which at least some aspects of the disclosed technology are implemented to measure light levels of a fiber-optic cable that terminates in a Lucent connector.

FIG. 6 is a flowchart of a process that implements a method for measuring light levels of a fiber-optic cable.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The disclosed technology relates to devices and methods for using a mobile device for measuring light levels in a fiber-optic cable so as to determine quality of a fiber-optic cable and communication (e.g., continuity of the fiber-optic cable). The device includes an adapter that can be positioned on an optical sensor of the mobile device. In some implementations, the optical sensor can be a camera of the mobile device. In some implementations, the optical sensor can be an ambient light sensor of the mobile device. The adapter can include a connector to receive at least one of a variety of fiber-optic cable connectors, such as a Lucent connector (also referred to herein as LC connector). The device also includes an attachment base to hold the mobile device and an arm to which the adapter is coupled. Since different mobile devices can have different camera and sensor layouts, the adapter is movable and can be slid along the arm to allow positioning the adapter above a desired optical sensor of the mobile device. In some implementations, compatibility of the apparatus with different mobile device layouts can be further enhanced by configuring the arm to be rotatable.

The disclosed technology further includes a software application (app) implemented as instructions stored on a non-transitory, computer-readable medium that can be executed by a processor. The software application can implement at least some aspects of a method disclosed herein to perform a light level test of the fiber-optic cable. The method can comprise coupling the mobile device to the attachment base, positioning the adapter to which the fiber-optic cable to be tested is coupled on the optical sensor of the mobile device, and taking, using the software application, two light level readings: the first reading when the fiber-optic cable is not illuminated by a light source, and the second reading when the fiber-optic cable is illuminated by the light source. When a difference between the two readings is greater than a threshold, the method further includes determining that the fiber-optic cable has passed sufficient light for measurement of a light level test. When the difference between the two readings is less than the threshold, the method further includes determining that the fiber-optic cable has not passed sufficient light, thereby failing the light level test. The test result can be used to determine the cause for communication issues, e.g., whether issues are related to the continuity of the fiber-optic cable.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Measuring Light Levels in a Fiber-optic Cable Using a Mobile Device

Fiber-optic cables, which are often made of glass or plastic, are fragile and can develop internal breaks, imperfections, or discontinuities that affect their ability to transmit light. There exists a need to test the continuity of a fiber-optic cable by assessing whether and how much light can pass through it, e.g., measuring light level in the fiber-optic cable. The light level in a fiber-optic cable also needs to be measured when troubleshooting a communications circuit during an outage, or during initial testing for accepting a communications circuit from a vendor. Conventional light meters available in the market are often either bulky and expensive or small and easily misplaced. In some cases, the potentially damaged fiber-optic cable needs to be sent for testing to an external party, incurring a high cost as well as delay in testing a communications circuit. Thus, there exists a need for cheap, portable, and ubiquitously available apparatus for testing and operational acceptance of a fiber-optic cable deployed to connect various network elements, routers, and circuits in a telecommunications network. Recognizing such a need, the inventors listed in this patent application disclose apparatus and methods for testing the fiber-optic cable using a mobile device such as a smartphone. Most modern smartphones include camera sensors for capturing images, and these sensors can be repurposed to measure the light level in the fiber-optic cable. Many smartphones also include a variety of optical sensors such as ambient light sensors that can also be repurposed to test the fiber-optic cable. Using commonly available equipment such as smartphones can reduce the time and cost associated with the testing.

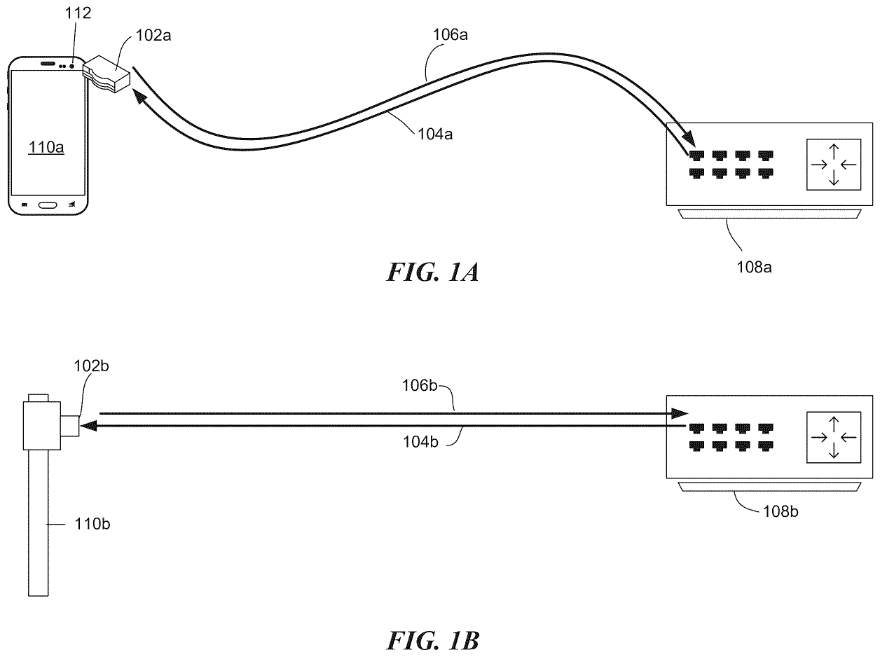

The disclosed technology relates to apparatus and methods for using a mobile device for measuring light level in a fiber-optic cable, so as to determine the quality of the fiber-optic cable, such as continuity. FIGS. 1A and 1B illustrate an example of a testing configuration in accordance with one or more embodiments of the present technology. As shown in FIG. 1A, a testing apparatus includes an adapter 102a for receiving the fiber-optic cable 104a to be tested. In some embodiments, the fiber-optic cable 104a can be part of a pair of fiber-optic cables 104a and 104b in which fiber-optic cable 104a is configured to be a transmit cable that transmits a light signal emitted by a light source 108a, and fiber-optic cable 104b is configured to be a receive cable that carries an optical signal to the light source 108a. In some implementations, the light source 108a can be a router. In some implementations, the light source 108b can be a fiber patch panel. In the testing configuration, a first end of the adapter 102a, referred to herein as a sensor end, can be placed on an optical sensor 112 of the mobile device 110a. In some embodiments, the optical sensor 112 can be a camera of the mobile device 110a. In some embodiments, the optical sensor 112 can be an ambient light sensor of the mobile device 110a. A second end of the adapter 102a can include a connector that can be configured to receive fiber-optic cables that terminate in at least one of a variety of connectors such as Subscriber Connectors (SC), Lucent Connectors (LC), straight tip (ST) connectors, ferrule connectors (FC), or mechanical transfer registered jack (MT-RJ) connectors. Adapters that include connectors compatible with other types of fiber-optic cable connectors are also possible. FIG. 1B illustrates a side view of the configuration shown in FIG. 1A, with 102b being the adapter, 110b being the mobile device, 104b and 106b being the transmit fiber-optic cable and the receive fiber-optic cable, respectively, and 108b being the light source.

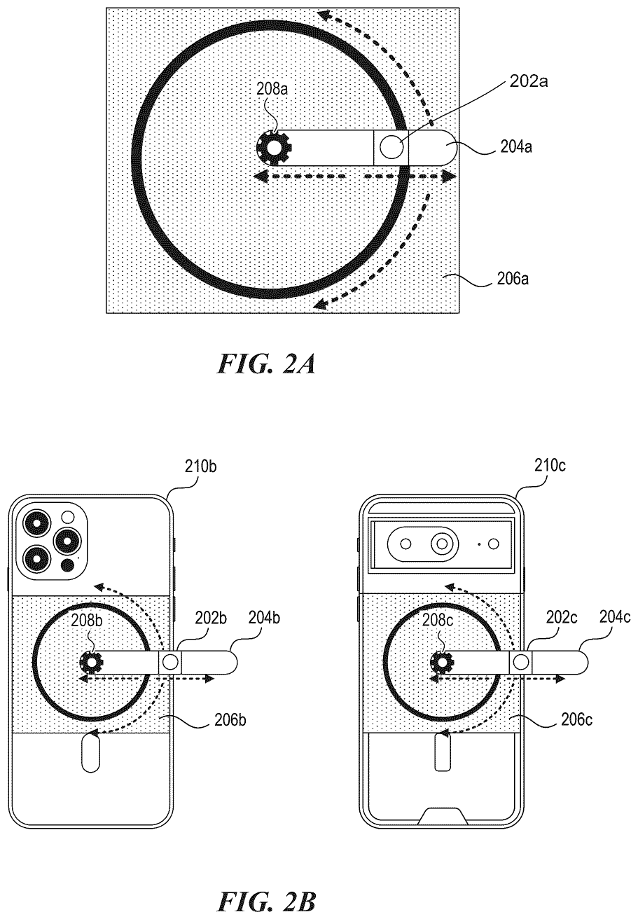

FIGS. 2A and 2B illustrate an example of a testing apparatus in accordance with one or more embodiments of the present technology. In FIG. 2A, the adapter 202a is coupled to a mobile device via an arm 204a. In some embodiments, the sensor end of the adapter 202a can include a gasket to block ambient light from entering the optical sensor when the adapter 202a is positioned over the optical sensor. The gasket can be composed of a variety of materials, for example thermoplastic polyurethane (TPU). In some embodiments, the gasket can be a dark color to further block ambient light from entering the optical sensor. In some embodiments, the apparatus can include an attachment base 206a configured to receive the mobile device. In some embodiments, the attachment base 206a can include a magnetic plate that can be magnetically coupled to a magnetic region on a back surface of the mobile device. In some embodiments, the attachment base 206a can include a spring-loaded clip configured to hold the mobile device in position by a frictional force. In some embodiments, the attachment base 206a can have a circular shape. In some embodiments, the attachment base 206a can have a rectangular shape, or other shapes that are suitable for use with mobile devices. In some embodiments, the arm 204a can be coupled to the adapter 202a and the attachment base 206a. In some embodiments, the adapter 202a can be adaptively repositioned along the arm 204a by sliding the adapter 202a. In some embodiments, the arm 204a can be further rotatable about an attachment point of the arm 204a to the attachment base 206a. In some embodiments, the arm 204a can be stabilized into a position by a fastening mechanism such as, for example, a fastening mechanism 208a (e.g., a tightening nut, screw, bolt, etc.) located at a proximal end of the arm 204a. Other forms of fastening mechanisms such as, for example, ball and socket joints or rivets are also possible. FIG. 2B shows examples of the apparatus of FIG. 2A coupled to various mobile devices 210b and 210c, each having different dimensions and optical sensor layouts. For example, mobile device 210b can be an Apple iPhone and mobile device 210c can be a Google Pixel device. These are illustrative examples only, and trademarks to the commercial names and products mentioned herein are owned by their respective owners. In FIG. 2B, the adapter is represented by 202b and 202c, the arm by 204b and 204c, the attachment base by 206b and 206c, and the tightening nut by 208b and 208c, respectively. The adapter 202b, 202c can be adaptively positioned according to the position of the optical sensor (e.g., camera) of the mobile devices.

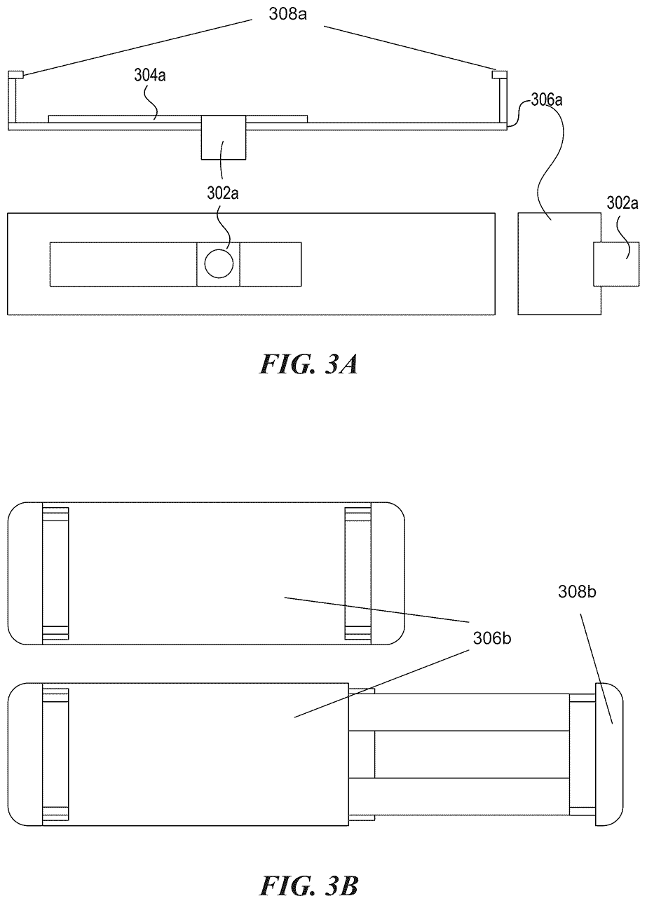

FIG. 3A illustrates a top view, a back view, and a side view of another example of a testing apparatus in accordance with one or more embodiments of the present technology. In FIG. 3A, the adapter 302a, the attachment base 306a, and the arm 304a have structures and functions as described in previous sections of this document. The adapter 302a can be coupled to the mobile device via the arm 304a. In some embodiments, the sensor end of the adapter 302a can include a gasket to block ambient light from entering the optical sensor when the adapter 302a is positioned over the optical sensor. The gasket can be composed of a variety of materials, for example thermoplastic polyurethane (TPU). In some embodiments, the gasket can be a dark color to further block ambient light from entering the optical sensor. In some embodiments, the apparatus can include an attachment base 306a configured to receive the mobile device. In some embodiments, the attachment base 306a can include a spring-loaded clip configured to hold the mobile device in position between gripping ends 308a by a frictional force. In some embodiments, the arm 304a can be coupled to the adapter 302a and the attachment base 306a. In some embodiments, the adapter 302a can be adaptively repositioned along the arm 304a by sliding the adapter 302a.

FIG. 3B illustrates a back view of another example of a testing apparatus in accordance with one or more embodiments of the present technology. In FIG. 3B, the attachment base 306b has a structure and function as described in previous sections of this document. In some embodiments, the attachment base 306b can include an extensible grip 308b for holding the mobile device in position by a frictional force. The extensible grip 308b can be configured to receive mobile devices of varying widths by variably extending the extensible grip 308b.

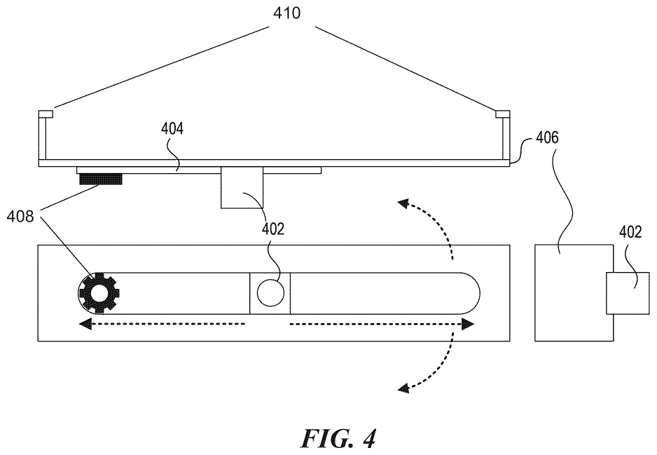

FIG. 4 illustrates a top view, a back view, and a side view of another example of a testing apparatus in accordance with one or more embodiments of the present technology. In FIG. 4, the adapter 402, the arm 404, the attachment base 406, and the fastening nut 408 have structures and functions as described in previous sections of this document. The adapter 402 can be coupled to a mobile device via the arm 404. In some embodiments, the sensor end of the adapter 402 can include a gasket to block ambient light from entering the optical sensor when the adapter 402 is positioned over the optical sensor. The gasket can be composed of a variety of materials, for example thermoplastic polyurethane (TPU). In some embodiments, the gasket can be a dark color to further block ambient light from entering the optical sensor. In some embodiments, the apparatus can include an attachment base 406 configured to receive the mobile device. In some embodiments, the attachment base 406 can include a magnetic plate that can be magnetically coupled to a magnetic region on a back surface of the mobile device. In some embodiments, the attachment base 406 can include a spring-loaded clip configured to hold the mobile device in position by a frictional force. In some embodiments, the arm 404 can be coupled to the adapter 402 and the attachment base 406. In some embodiments, the adapter 402 can be adaptively repositioned along the arm 404 by sliding the adapter 402. In some embodiments, the arm 404 can be further rotatable about an attachment point of the arm 404 to the attachment base 406. In some embodiments, the arm 404 can be stabilized into a position by a fastening mechanism such as, for example, a tightening nut, screw, or bolt 408 located at a proximal end of the arm 404. Other forms of fastening mechanisms such as, for example, ball and socket joints or rivets are also possible. In some embodiments, the attachment base 406 can include a spring-loaded clip configured to hold the mobile device in position between gripping ends 410 by a frictional force.

The technology disclosed herein further includes a software application comprising instructions stored in a non-transitory, computer-readable storage medium, the instructions being capable of being executed by a processor. In some embodiments, the software application can be configured to implement some aspects of a method for measuring light levels in the fiber-optic cable using the mobile device. In some embodiments, the method can include receiving, via a user interface of a mobile device, an indication from a user to measure a light level incident on an optical sensor of the mobile device. In some embodiments, the method includes coupling the mobile device with the apparatus. In some embodiments, the method includes coupling a first end of the fiber-optic cable to the connector end of the adapter and a second end of the fiber-optic cable to a light source such as a router or a fiber patch panel, and positioning the sensor end of the adapter on the optical sensor of the mobile device. In some embodiments, the method includes taking a first light level reading when the light source is not illuminating the second end of the fiber-optic cable. In some embodiments, the method further includes taking a second light level reading when the light source illuminates the second end of the fiber-optic cable. In some implementations, when a difference between the first and the second light level readings exceeds a first threshold, the fiber-optic cable can be determined to have passed the light level test, and when the difference does not exceed the first threshold, the fiber-optic cable can be determined to have failed the light level test. In some implementations, the software application can represent the light level readings in units of dBm whereas in some other implementations, the software application can represent the light level readings in units of milliwatts (mW).

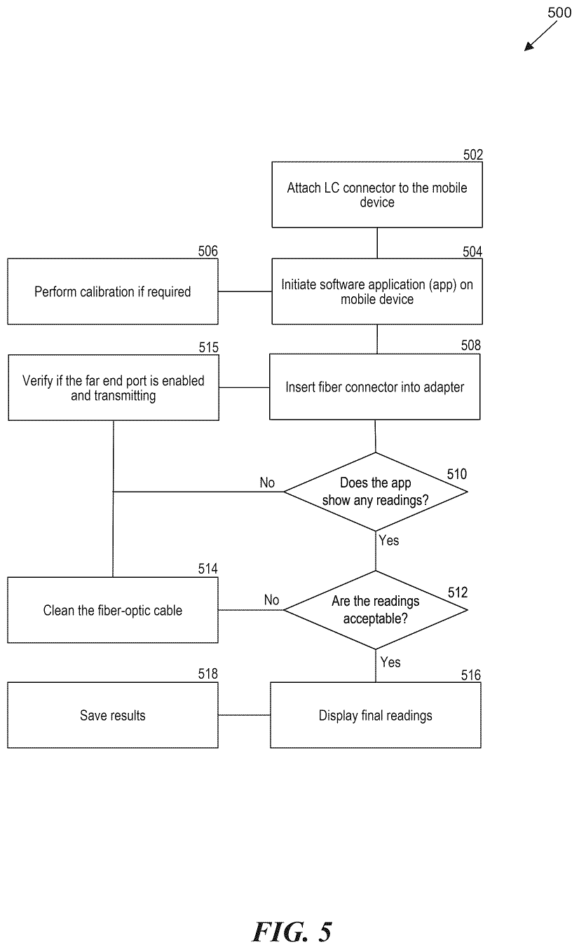

FIG. 5 is a flowchart of a process 500 in which at least some aspects of the disclosed technology are implemented to measure the light level in a fiber-optic cable that terminates in a Lucent connector. At 502, after positioning the mobile device in the attachment base of the apparatus and the adapter on the optical sensor of the mobile device, the adapter is configured to receive the Lucent connector of the fiber-optic cable. At 504, the software application is initiated on the mobile device. In some embodiments, at 506, the software application and the apparatus can be calibrated to provide an accurate reading. In some embodiments, the calibration can include, for example, taking a calibration measurement of a current light level reading and denoting the calibration measurement as a zero light level reading. At 508, the Lucent connector of the fiber-optic cable can be coupled to the adapter. At 510, when the fiber-optic cable is illuminated by a light source, the software application determines whether a light level reading is obtained or measures the light level incident on the optical sensor of the mobile device. If no light level reading is obtained or if the light level is measured to be zero, a calibration as described in step 506 can be performed. At 512, if a light level reading has been obtained in step 510, the software application can compare the reading to a first threshold. At 514, when the reading is less than the first threshold, an operator of the apparatus can clean the fiber-optic cable and perform the calibration described in step 506. At 515, the operator of the apparatus can verify whether a far end port, i.e., the light source, connected to the fiber-optic cable is enabled and transmitting a light signal. At 516, when the light level reading is greater than the first threshold, the software application can display the reading on a display screen of the mobile device. At 518, the software application can optionally store the reading in a non-transitory, computer-readable storage of the mobile device.

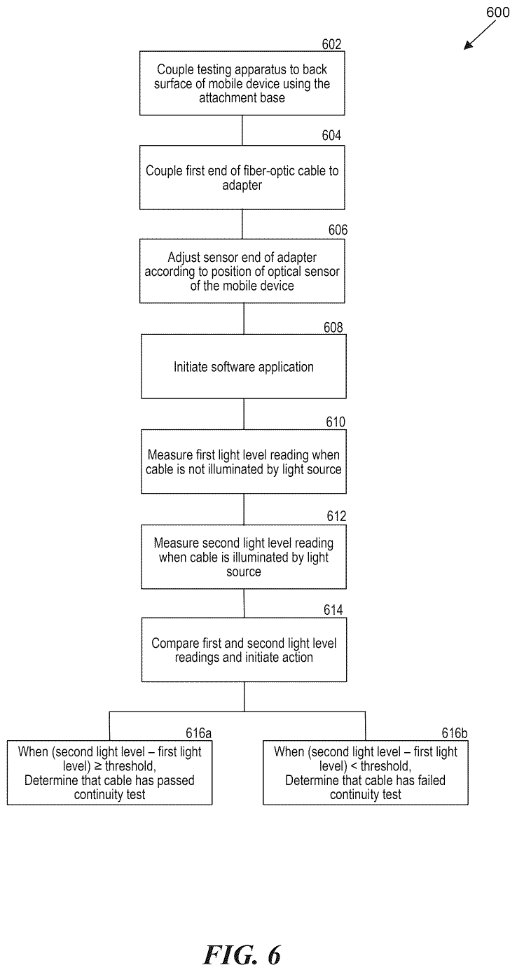

FIG. 6 is a flowchart of a process 600 that implements a method for measuring a light level in a fiber-optic cable comprising a first end and a second end using a mobile device. At 602, a testing apparatus is coupled to a back surface of the mobile device via an attachment base of the testing apparatus. In some implementations, the testing apparatus can comprise an adapter, an arm coupled to the adapter such that the adapter is configured to movably slide between a proximal end and a distal end of the arm, and the attachment base. At 604, the first end of the fiber-optic cable can be coupled to the adapter. The adapter can comprise a sensor end, and a connector configured to couple to the first end of the fiber-optic cable. At 606, the sensor end of the adapter can be adjusted according to a position of an optical sensor of the mobile device. In some implementations, the optical sensor to which the sensor end of the adapter is coupled can be a camera of the mobile device. In some implementations, the optical sensor to which the sensor end of the adapter is coupled can be an ambient light sensor of the mobile device. In some embodiments, the sensor end of the adapter can include a gasket configured to block light between the adapter and the mobile device upon the adapter being positioned on an optical sensor of the mobile device. At 608, a software application can be initiated on the mobile device. The software application can be configured to measure a light level from the fiber-optic cable incident on the optical sensor of the mobile device. At 610, the software application can measure a first light level reading when the second end of the fiber-optic cable is not illuminated by a light source. At 612, the software application can measure a second light level reading when the second end of the fiber-optic cable is illuminated by a light source. In some implementations, the light source can be a router that includes a small form-factor pluggable (SFP) interface. In some implementations, the light source can be a fiber patch panel. At 614, at least one action can be initiated based on a comparison of the first light level reading and the second light level reading. At 616a, the at least one action can comprise determining, when a difference between the first light level reading and the second light level reading is greater than or equal to a first threshold, that the fiber-optic cable has passed a light level test. At 616b, the at least one action can comprise determining, when a difference between the first light level reading and the second light level reading does not exceed a first threshold, that the fiber-optic cable has failed a light level test.

### Computer System

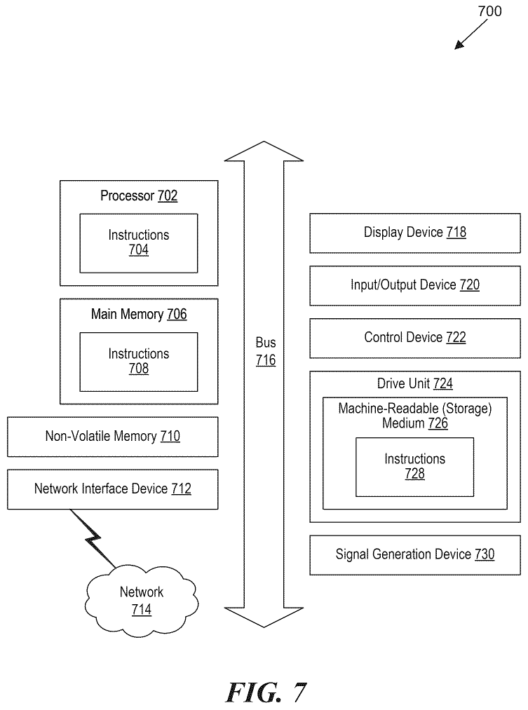

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. An apparatus for measuring a light level in a fiber-optic cable using a mobile device, the apparatus comprising:
an adapter comprising a sensor end and a connector,
wherein the connector of the adapter is configured to couple to the fiber-optic cable to be tested, and
wherein the sensor end of the adapter includes a gasket configured to block light between the adapter and the mobile device upon the adapter being positioned on an optical sensor of the mobile device;
an arm coupled to the adapter, the arm comprising a proximal end and a distal end,
wherein the adapter is movably coupled to the arm and configured to slide between the proximal end and the distal end; and
an attachment base coupled to the arm and removably coupled to a back surface of the mobile device.

2. The apparatus of claim 1, wherein the attachment base includes a magnetic plate, and wherein the magnetic plate is configured to receive the mobile device by magnetically coupling to a magnetic region on the back surface of the mobile device.

3. The apparatus of claim 1, wherein the attachment base includes a spring-loaded clip configured to hold the mobile device in position by a frictional force.

4. The apparatus of claim 1, further comprising:
a fastening mechanism located at the proximal end of the arm,
wherein the arm is coupled to the attachment base at the proximal end of the arm such that the arm is rotatable about the fastening mechanism at the proximal end of the arm where the arm is coupled to the attachment base.

5. The apparatus of claim 1, wherein the attachment base has a circular or a rectangular shape.

6. The apparatus of claim 1, wherein the gasket comprises a thermoplastic polyurethane (TPU) material.

7. The apparatus of claim 1, wherein the gasket is a dark color to reduce light between the adapter and the mobile device.

8. The apparatus of claim 1, wherein the fiber-optic cable terminates in one of: a Lucent Connector (LC), a Subscriber Connector (SC), a ferrule connector (FC), a mechanical transfer registered jack (MT-RJ) connector, or a straight tip (ST) connector.

9. A method for measuring a light level in a fiber-optic cable comprising a first end and a second end using a mobile device, the method comprising:
coupling a testing apparatus to a back surface of the mobile device via an attachment base of the testing apparatus,
wherein the testing apparatus comprises an adapter, an arm coupled to the adapter such that the adapter is configured to movably slide between a proximal end and a distal end of the arm, and the attachment base;
coupling the first end of the fiber-optic cable to the adapter,
wherein the adapter comprises a sensor end and a connector,
wherein the connector of the adapter is configured to couple to the first end of the fiber-optic cable;
adjusting the sensor end of the adapter according to a position of an optical sensor of the mobile device,
wherein the sensor end of the adapter includes a gasket configured to block light between the adapter and the mobile device upon the adapter being positioned on the optical sensor of the mobile device;
initiating, on the mobile device, a software application configured to measure a light level from the fiber-optic cable coupled to the optical sensor of the mobile device;
measuring, by the software application, a first light level reading when the second end of the fiber-optic cable is not illuminated by a light source;
measuring, by the software application, a second light level reading when the second end of the fiber-optic cable is illuminated by a light source; and
initiating at least one action based on a comparison of the first light level reading and the second light level reading.

10. The method of claim 9, wherein the at least one action comprises:
determining, when a difference between the first light level reading and the second light level reading exceeds a first threshold, that the fiber-optic cable has passed a light level test.

11. The method of claim 9, wherein the at least one action comprises:
determining, when a difference between the first light level reading and the second light level reading does not exceed a first threshold, that the fiber-optic cable has failed a light level test.

12. The method of claim 9, wherein the optical sensor to which the sensor end of the adapter is coupled comprises a camera of the mobile device.

13. The method of claim 9, wherein the optical sensor to which the sensor end of the adapter is coupled comprises an ambient light sensor of the mobile device.

14. The method of claim 9, wherein the light source comprises a router that includes a small form-factor pluggable (SFP) interface or a fiber patch panel.

15. A non-transitory, computer-readable storage medium comprising instructions recorded thereon, wherein the instructions, when executed by at least one data processor of a system, cause the system to:
receive, via a user interface of a mobile device, an indication from a user to measure a light level incident on an optical sensor of the mobile device from a fiber-optic cable comprising a first end and a second end,
wherein the first end of the fiber-optic cable is positioned above the optical sensor via a testing apparatus coupled to a back surface of the mobile device,
wherein the testing apparatus comprises an adapter, an arm coupled to the adapter such that the adapter is configured to movably slide between a proximal end and a distal end of the arm, and an attachment base configured to attach the testing apparatus to the mobile device,
wherein the adapter comprises a sensor end and a connector, and
wherein the connector of the adapter is configured to couple to the first end of the fiber-optic cable;
determine a first light level reading when the second end of the fiber-optic cable is not illuminated by a light source;
determine a second light level reading when the second end of the fiber-optic cable is illuminated by the light source; and
initiate at least one action based on a comparison of the first light level reading and the second light level reading.

16. The non-transitory, computer-readable storage medium of claim 15, wherein the at least one action comprises causing the system to:
determine, when a difference between the first light level reading and the second light level reading exceeds a first threshold, that the fiber-optic cable has passed a light level test.

17. The non-transitory, computer-readable storage medium of claim 15, wherein the at least one action comprises causing the system to:
determine, when a difference between the first light level reading and the second light level reading does not exceed a first threshold, that the fiber-optic cable has failed a light level test.

18. The non-transitory, computer-readable storage medium of claim 15, wherein the optical sensor comprises a camera of the mobile device.

19. The non-transitory, computer-readable storage medium of claim 15, wherein the optical sensor comprises an ambient light sensor of the mobile device.

20. The non-transitory, computer-readable storage medium of claim 15, wherein the light source is a router that includes a small form-factor pluggable (SFP) interface or a fiber patch panel.
